(19) United States
(12) Patent Application Publication
(10) Pub. No.: US 2011/0021066 A1
(43) Pub. Date: Jan. 27, 2011

(54) Power selector inlet

(76) Inventor: Robert Squires, Orton (CA)

Correspondence Address: LAW OFFICE OF KYLE FLETCHER, P.O. Box 11735, CHARLOTTE, NC, 28220, US

(21) Appl. No.: 12/506,430

(22) Filed: Jul. 21, 2009

(51) Int. Cl. H01R 11/00

(52) U.S. Cl. 439/502

(57) ABSTRACT

The present invention is a male recessed inlet for use with either an alternative power source or standard electricity via an extension cord that comprises the male recessed inlet, wiring, and a separate standard wall outlet. The male recessed inlet is wired to the standard wall outlet and is located in places where such an inlet is desirable.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

A. Field of the Invention

The present invention relates to the field of recessed inlets, more specifically, a male recessed inlet that is wired from one location of a structure to another location, and of which enables an electrical supply from an alternative energy source or a surge protector connected to a standard electrical supply to become available.

The use of alternative energy sources is becoming more viable and is a desired option for those who live in remote locations or are wary of the environmental impact associated with traditional electrical supplies.

A need exists for a recessed inlet to be wired into a structure, dwelling, or building that is wired to a traditional wall outlet at another location that is accessible to the alternative energy source as well as to another typical wall outlet. In the event of a rolling blackout, natural disaster where standard electricity is not available, or some other unforeseen instance, the male recessed inlet is an available power source that can be easily connected to a generator, a battery bank that is powered by an alternative energy source (solar, wind, geothermal, etc.), or a standard wall outlet via a typical extension cord. In the event that electricity is supplied via a standard wall outlet, a surge protector may be used in order to supply electricity for expensive appliance that would benefit from the capabilities associated with surge protectors.

B. Discussion of the Prior Art

As a preliminary note, it should foe stated that there is an ample amount of prior art that deals with electrical outlets, surge protectors.

The Luu Patent (U.S. Pat. No. 5,384,428) discloses an in-wall electrical power receptacle with a built-in surge protector for wall-mounted appliances. However, receptacle did not have a recessed male plug that ran from one location of a structure to another, and of which enabled access to alternative energy sources or a standard electrical supply.

Murphy et al. Patent (U.S. Pat. No. 4,872,081) discloses a duplex electrical receptacle with a built-in surge protection device. Again, the electrical receptacle does not have a recessed male plug that connects with a surge protector or standard electrical outlet or with an alternative energy supply.

The Johnson Patent (U.S. Pat. No. 6,593,723) discloses an integrated wall apparatus with electrical outlets that delivers uninterrupted electrical power to outlets. Again, the electrical outlets do not have a recessed male plug.

The King Patent (U.S. Pat. No. 6,309,248) discloses a modular electrical outlet with the outlet having a built-in surge protection device. However, the electrical outlet does not receive electricity from a surge protector or alternative electrical supply, and has a recessed male plug.

The Yu Patent (U.S. Pat. No. 6,297,450) discloses an electrical outlet with a section of inserting a surge protection apparatus. However, the electrical outlet does not feature a recessed male outlet for connection with a standard electrical supply or alternative power source.

The Maglionico et al. Patent (U.S. Pat. No. Des. 523,397) illustrates a design or an cutlet that has surge protection and is an uninterrupted power source, which does not depict a recessed male plug.

The Mercer Patent Application Publication (U.S. Pub. No. 2005/0269881) discloses a separately derived isolated ground interface and more particularly to a power interface box for connecting isolated ground receptacles. However, the isolated ground interface apparatus does not have a recessed male plug that connects with either an alternative power source or standard electricity via an extension cord.

Pyrros Patent (U.S. Pat. No. 6,955,559) discloses a multiplex electrical outlet receptacle comprising a housing containing four or more receptacle outlets. Again, the electrical receptacle does not have a recessed male plug that connects with either an alternative power source or standard electricity via an extension cord.

While the above-described devices fulfill their respective and particular objects and requirements, they do not describe a male recessed inlet for use with either an alternative power source or standard electricity via an extension cord. In this regard, the male recessed inlet departs from the conventional concepts and designs of the prior art.

### BRIEF SUMMARY OF THE INVENTION

The present invention is a male recessed inlet for use with either an alternative power source or standard electricity via an extension cord that comprises the male recessed inlet, wiring, and a separate standard wall outlet. The male recessed inlet is wired to the standard wall outlet and is located in places where such an inlet is desirable.

An object of the invention is to provide an electrical inlet that provides electrical connectivity with either an alternative power source or standard electricity via an extension cord.

A further object of the invention is to provide a male recessed outlet that easily receives electricity from a surge protector or other wall outlet via an extension cord in order to provide surge protection capabilities.

These together with additional objects, features and advantages of the male recessed inlet will be readily apparent to those of ordinary skill in the art upon reading the following detailed description of presently preferred, but nonetheless illustrative, embodiments of the male recessed inlet when taken in conjunction with the accompanying drawings.

In this respect, before explaining the current embodiments of the male recessed inlet in detail, it is to be understood that the male recessed inlet is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the male recessed inlet. It is therefore important that the claims be regarded as including such equivalent construction insofar as they do not depart from the spirit and scope of the male recessed inlet. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a front, isometric view of the male, recessed inlet;

FIG. 2 illustrates a rear, isometric view of the male recessed inlet;

FIG. 3 illustrates a front, isometric view of the male, recessed inlet with a cover;

FIG. 4 illustrates a rear view of the male recessed inlet;

FIG. 5A illustrates a view of the invention in use with an extension cord, a surge protector, and a TV plug;

FIG. 5B illustrates a view of the invention in use with an extension cord, a small generator, and a TV plug; and

FIG. 5C illustrates a view of the invention in use with an extension cord; a battery back with inverter powered via wind, solar, or geothermal; and a TV plug.

### DETAILED DESCRIPTION OF THE EMBODIMENT

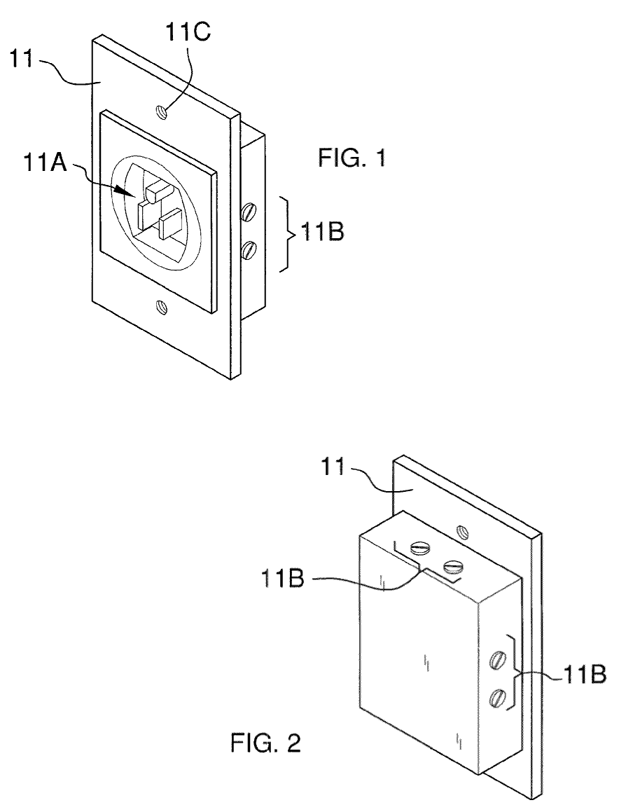

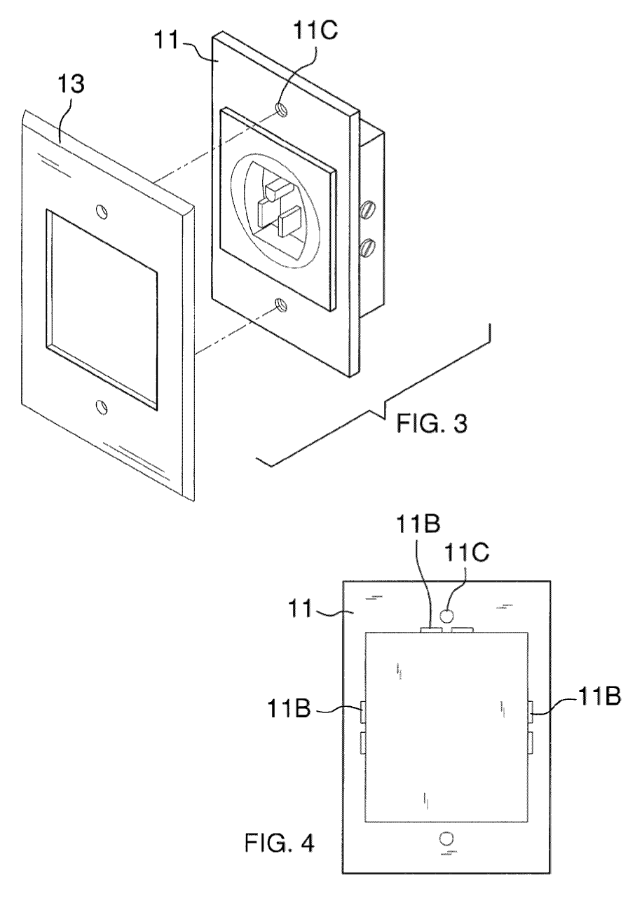

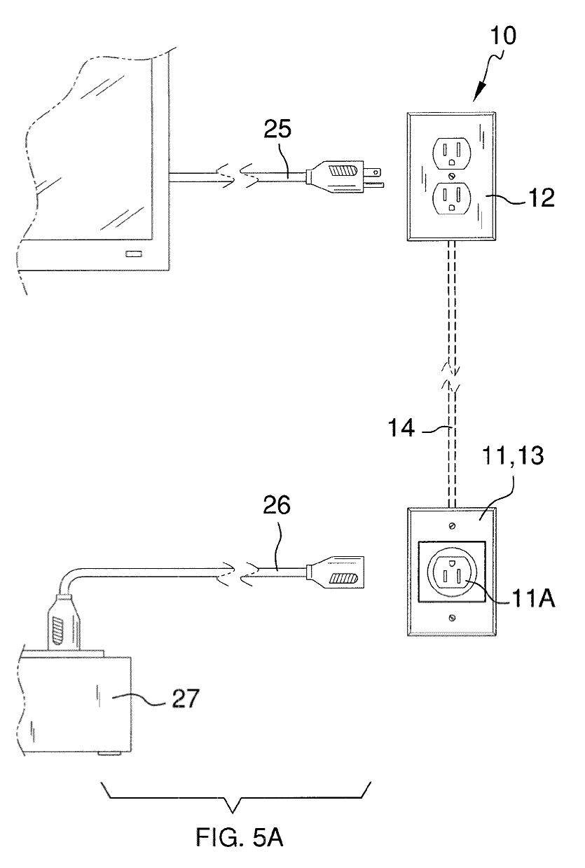

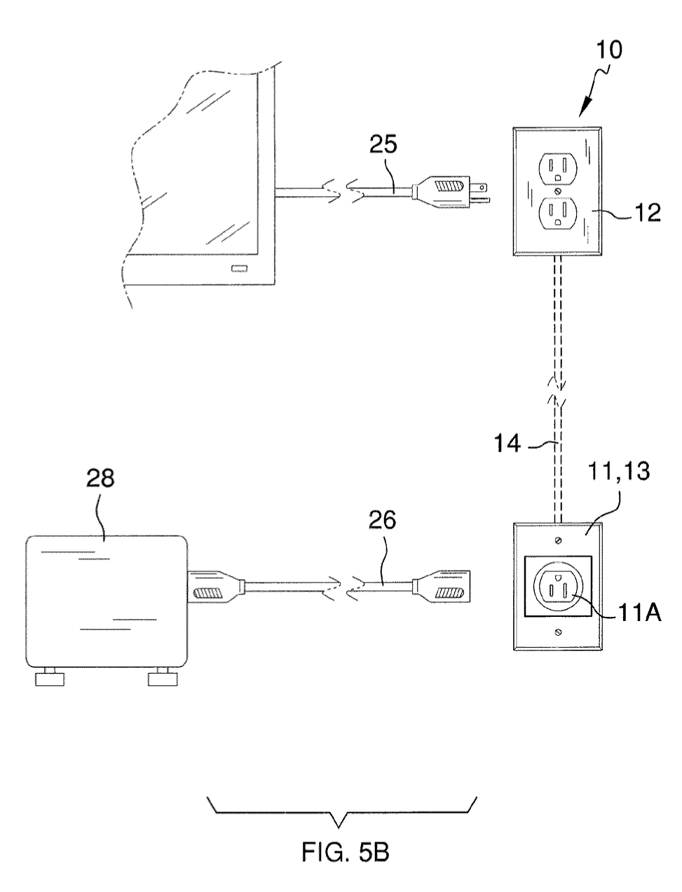

Detailed reference will now be made to the present invention, examples of which are illustrated in FIGS. 1-5C. A male recessed inlet system 10 (hereinafter invention) includes a male recessed inlet 11, a cover standard wall, outlet 12, a cover 13, and wiring 14.

The male recessed inlet 11 has a male plug 11A that is recessed from within the male recessed inlet 11. The male recessed inlet 11 also has a plurality of connection points 11B, and mounting holes 11C. It shall be noted that the male recessed inlet 11 is capable of being wiredly connected via wiring 14 to a plurality of standard wall outlets 12. It shall also be noted that the male recessed outlet 11 may alternatively have a single set of connection points 11B from which a single standard wall outlet 12 may be connected.

It shall also be noted that in the event that a multitude of standard wall outlets 12 are used, the locations of the standard wall outlets 12 shall be in varying locations around a structure, and are only wired to either the male recessed inlet 11 or one of the remaining standard wall outlets 12, and not directly to a standard wall outlet that is supplied electricity from either an alternative power source or a standard electrical supply. The alternative power source may involve a battery bank with inverter 29 that is charged by solar, wind, or geothermal energy powering means. The alternative power source may also involve an auxiliary generator that is powered by a hydrocarbon comprising gasoline, diesel fuel, propane, butane, ethanol, or methane.

It is envisioned that the invention 10 may have multiple electrical supplies coming from a multitude of standard wall outlets 12, which are collectively supplying electricity to the male recessed inlet 11. Electricity shall only be supplied to the invention 10 via an electrical drop cord (not shown) or a surge protector 27. It shall also be noted that the invention 10 can be rated for a plurality of amperages comprising 5 amps, 10 amps, 15 amps, 20 amps, 25 amps, or as much as 100 amps.

Wiring 14 connects the male recessed inlets 11 via one of the connection points 11B to the standard wall outlet 12.

The cover 13 secures the male recessed inlet 11 to a surface via the mounting holes 11C. It shall be noted that variations of the invention 10 may exclude the cover 13. However, the male recessed inlets 11 are designed to be mounted into a standard electrical outlet box in or on a wall.

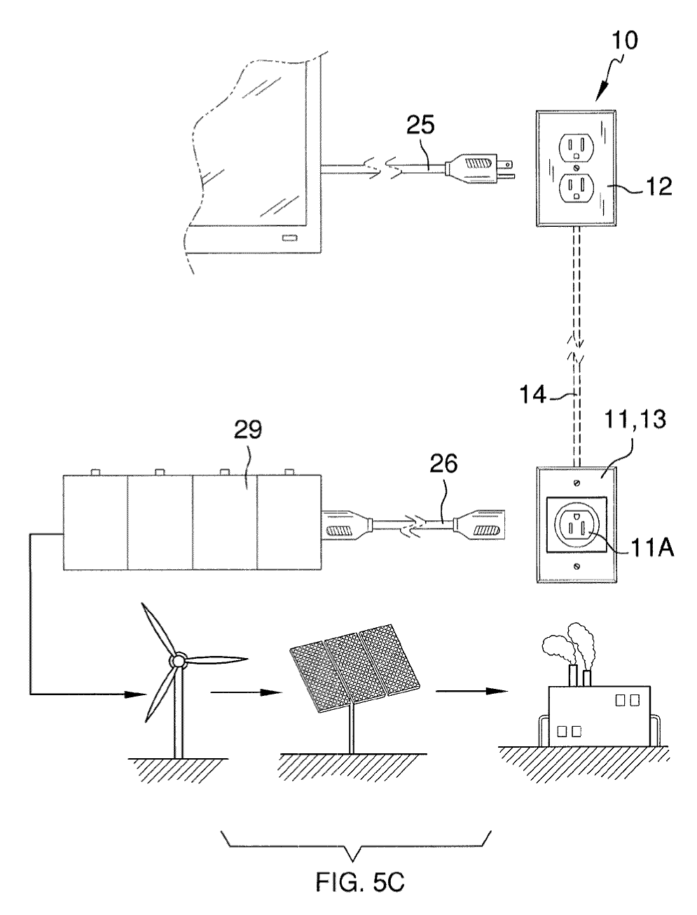

The invention 10 is designed to be used where access to a typical electrical wiring system is not available or where surge-protection is desired or where electricity supplied by an alternative energy source is desired. Referring to FIG. 5, an example of a particular use of the invention 10 involves an appliance 25 (a TV Plug in this case), an extension cord 26, and the surge protector 27. It shall also be noted that the configuration in FIG. 5 may be adapted to allow the invention 10 to be plugged into a standard wall outlet (not depicted) with an electrical supply directly via the extension cord 26.

With respect to the above description, it is to be realized that the optimum dimensional relationship for the various components of the invention 10, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 10.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A male recessed inlet system comprising:
(a) a male recessed inlet;
wherein the male recessed outlet features a single male plug that is recessed;
wherein the male recessed inlet includes a single set of connection points;
(b) a standard wall outlet;
wherein the standard wall outlet is connected via wiring to the set of connection points of the male recessed inlet;
wherein the standard wall outlet is mounted to a wall;
wherein an extension cord plugs the standard wall outlet to an electrical supply; and
wherein the male recessed inlet supplies electricity supplied from the standard wall outlet.

2. The male recessed inlet system as described in claim 1 wherein the electrical supply comprises a standard electrical supply via a standard wall outlet, electricity supplied via an auxiliary generator, or electricity supplied from a battery bank with inverter powered by an alternative energy source further comprising solar, wind, or geothermal powering means.

3. The male recessed inlet system as described in claim 2 wherein the auxiliary generator is powered by a hydrocarbon comprising gasoline, diesel fuel, propane, butane, ethanol, or methane.

4. The male recessed inlet system as described in claim 1 wherein the male recessed inlet has mounting holes for mounting to a surface or a standard electrical outlet box.

5. The male recessed inlet system as described in claim 1 wherein a cover is included and which secures the male recessed inlet to a surface via the mounting holes.

6. A male recessed inlet system comprising:
(a) a male recessed inlet;
wherein the male recessed outlet features a single male plug that is recessed;
wherein the male recessed inlet includes a plurality of connection points;
(b) a plurality of standard wall outlets;
wherein the standard wall outlets are each connected via wiring to the one of the sets of connection points of the male recessed inlet;
wherein the standard wall outlets are mounted to a wall;
wherein an extension cord plugs an electrical supply into one of the standard wall outlets; and
wherein the male recessed inlet supplies electricity supplied from one of the standard wall outlets.

7. The male recessed inlet system as described in claim 6 wherein the electrical supply comprises a standard electrical supply via a standard wall outlet, electricity supplied via an auxiliary generator, or electricity supplied from a battery bank with inverter powered by an alternative energy source further comprising solar, wind, or geothermal powering means.

8. The male recessed inlet system as described in claim 7 wherein the auxiliary generator is powered by a hydrocarbon comprising gasoline, diesel fuel, propane, butane, ethanol, or methane.

9. The male recessed inlet system as described in claim 6 wherein the male recessed inlet has mounting holes for mounting to a standard electrical device box.

10. The male recessed inlet system as described in claim 6 wherein a cover is included and which secures the male recessed inlet to a standard electrical device box via the mounting holes.

11. A male recessed inlet system comprising:
(a) a male recessed inlet;
wherein the male recessed outlet features a single male plug that is recessed;
wherein the male recessed inlet includes a set of connection points;
(b) a plurality of standard wall outlets;
wherein the standard wall outlets are all connected together via wiring to the set of connection points of the male recessed inlet;
wherein the standard wall outlets are mounted to a wall;
wherein an extension cord plugs an electrical supply into one of the standard wall outlets; and
wherein the male recessed inlet supplies electricity supplied from one of the standard wall outlets.

12. The male recessed inlet system as described in claim 11 wherein the electrical supply comprises a standard electrical supply via a standard wall outlet, electricity supplied via an auxiliary generator, or electricity supplied from a battery bank with inverter powered by an alternative energy source further comprising solar, wind, or geothermal powering means.

13. The male recessed inlet system, as described in claim 12 wherein the auxiliary generator is powered by a hydrocarbon comprising gasoline, diesel fuel, propane, butane, ethanol, or methane.

14. The male recessed inlet system as described in claim 11 wherein a plurality of extension cords plug into a multitude of standard wall outlets in order to collectively supply electricity to the male recessed inlet.

15. The male recessed inlet system as described in claim 11 wherein the male recessed inlet has mounting holes for mounting to a standard electrical device box.

16. The male recessed inlet system as described in claim 11 wherein a cover is included and which secures the male recessed inlet to a standard electrical device box via the mounting holes.
